(19) United States
(12) Patent Application Publication
(10) Pub. No.: US 2019/0101916 A1
(43) Pub. Date: Apr. 4, 2019

(54) VEHICLE CONTROL APPARATUS, VEHICLE CONTROL METHOD, AND VEHICLE CONTROL PROGRAM

(71) Applicant: HONDA MOTOR CO., LTD., Minato-ku, Tokyo (JP)

(72) Inventors: Naoto Sen, Wako-shi (JP); Kunimichi Hatano, Wako-shi (JP); Masahiko Asakura, Wako-shi (JP); Masaaki Abe, Wako-shi (JP)

(21) Appl. No.: 16/086,635

(22) PCT Filed: Mar. 31, 2016
(86) PCT No.: PCT/JP2016/060864

§ 371 Date: Sep. 20, 2018

(51) Int. Cl. G05D 1/00; B60W 40/09; G06K 9/00

(52) U.S. Cl. CPC G05D 1/0061; G05D 1/0088; G05D 2201/0213; G06K 9/00845; B60W 40/09

(57) ABSTRACT

A vehicle control system includes a driving controller which controls automated driving of automatically controlling at least one of an acceleration/deceleration and steering of a host vehicle or manual driving of controlling both the acceleration/deceleration and steering of the host vehicle on the basis of an operation of an occupant of the host vehicle by executing any of a plurality of modes having different degrees of automated driving, a skill level recognizer which recognizes a skill level of the occupant of the host vehicle, and a mode controller which selects a mode implemented by the driving controller and controls a degree of change of the mode on the basis of the skill level recognized by the skill level recognizer.

### BACKGROUND OF THE INVENTION

### Field of the Invention

The present invention relates to a vehicle control apparatus, a vehicle control method, and a vehicle control program.

### Background Art

In recent years, research on a technology for automatically controlling at least one of the acceleration/deceleration and steering of a host vehicle (hereinafter, automated driving) has been conducted. With respect to this technology, a technology for executing automated driving control in any of a predetermined standard control mode or a specific control mode different from the standard control mode has been disclosed (for example, see Japanese Unexamined Patent Application, First Publication No. 2015-89801).

### SUMMARY OF THE INVENTION

In a case where automated driving modes are switched between a plurality of modes, or in a case of switching between automated driving and manual driving as in a conventional technique, the operational load on the driver performing the operation varies. It may be difficult for the occupant to cope with such variation.

An object of the present invention devised in view of the aforementioned circumstances is to provide a vehicle control apparatus, a vehicle control method and a vehicle control program capable of limiting variation in an operational load to a variation degree which an occupant is able to cope with.

The invention disclosed in claim 1 is a vehicle control system including: a driving controller (140, 142, 144, 146, 150 and 160) which controls automated driving of automatically controlling at least one of an acceleration/deceleration and steering of a host vehicle or manual driving of controlling both the acceleration/deceleration and steering of the host vehicle on the basis of an operation of an occupant of the host vehicle by implementing any of a plurality of modes having different degrees of automated driving; a skill level recognizer (155) which recognizes a skill level of the occupant of the host vehicle; and a mode controller (120) which selects a mode implemented by the driving controller and controls a degree of change of the mode on the basis of the skill level recognized by the skill level recognizer.

In the invention disclosed in claim 2, the mode controller increases a time or a traveling distance necessary for the driving controller to change modes as a skill level recognized by the skill level recognizer decreases in the invention disclosed in claim 1.

In the invention disclosed in claim 3, the driving controller changes a behavior of the host vehicle when automated driving is ended and manual driving is implemented on the basis of a skill level recognized by the skill level recognizer in the invention disclosed in claim 1.

In the invention disclosed in claim 4, the skill level recognizer counts the number of times each occupant of the host vehicle has been present on the basis of images captured by an image capturing unit which captures images and recognizes a skill level of an occupant of the host vehicle on the basis of the counted number of times of presence in the invention disclosed in claim 1.

The invention disclosed in claim 5 further includes a communication unit which communicates with an external device, wherein the skill level recognizer recognizes a skill level of an occupant of the host vehicle on the basis of a skill level acquired from the external device through the communication unit in the invention disclosed in claim 1.

In the invention disclosed in claim 6, the skill level recognizer transmits information based on an image captured by an image capture unit which captures an image of the interior of the vehicle to the external device using the communication unit in the invention disclosed in claim 5.

In the invention disclosed in claim 7, the mode controller limits modes which can be selected by the driving controller as a skill level of an occupant of the host vehicle decreases in the invention disclosed in claim 1.

In the invention disclosed in claim 8, the mode controller limits a difference between degrees of automated driving before and after mode change performed by the driving controller as a skill level of an occupant of the host vehicle decreases in the invention disclosed in claim 1.

In the invention disclosed in claim 9, when a difference between degrees of automated driving before and after mode change is limited, the mode controller sequentially changes modes within a limited range in the invention disclosed in claim 8.

The invention disclosed in claim 15 is a vehicle control method including, through a computer mounted in a vehicle: controlling automated driving of automatically controlling at least one of an acceleration/deceleration and steering of a host vehicle or manual driving of controlling both the acceleration/deceleration and steering of the host vehicle on the basis of an operation of an occupant of the host vehicle by executing any of a plurality of modes having different degrees of automated driving; recognizing a skill level of the occupant of the host vehicle; and selecting a mode implemented by a driving controller and controlling a degree of change of the mode on the basis of a skill level recognized by the skill level recognizer.

The invention disclosed in claim 11 is a vehicle control program causing a computer mounted in a vehicle: to control automated driving of automatically controlling at least one of an acceleration/deceleration and steering of a host vehicle or manual driving of controlling both the acceleration/deceleration and steering of the host vehicle on the basis of an operation of an occupant of the host vehicle by executing any of a plurality of modes having different degrees of automated driving; to recognize a skill level of the occupant of the host vehicle; and to select a mode implemented by a driving controller and control a degree of change of the mode on the basis of a skill level recognized by the skill level recognizer.

According to the invention described in each claim, it is possible to limit variation in an operational load to a variation degree which an occupant is able to cope with.

According to the invention described in claims 5 and 6, it is possible to share a skill level among a plurality of vehicles.

### BRIEF DESCRIPTION OF THE DRAWINGS

FIG. 1 is a diagram showing components of a host vehicle M.

FIG. 2 is a diagram illustrating a functional configuration focusing on the vehicle control system 100.

FIG. 3 is a block diagram of an HMI 70.

FIG. 4 is a diagram showing a state in which a host vehicle location recognizer 140 recognizes a relative location of a host vehicle M with respect to a traveling lane L1.

FIG. 5 is a diagram showing an example of an action plan generated in a certain section.

FIG. 6 is a diagram showing an example of a configuration of a trajectory generator 146.

FIG. 7 is a diagram showing an example of trajectory candidates generated by a trajectory candidate generator 146B.

FIG. 8 is a diagram representing trajectory candidates generated by the trajectory candidate generator 146B as trajectory points K.

FIG. 9 is a diagram showing a lane change target location TA.

FIG. 10 is a diagram showing a speed generation model when speeds of three surrounding vehicles are assumed to be constant.

FIG. 11 is a diagram showing an example of operation permissibility information 188 for each mode.

FIG. 12 is a diagram showing an example of contents of a skill level management table 190 managed by the skill level recognizer 155.

FIG. 13 is a diagram showing an example of contents of control reference information 192.

FIG. 14 is a flowchart showing an example of a flow of a process executed by an automated driving mode controller 130.

FIG. 15 is a diagram showing an example of speed variation when an automated driving mode is switched to a manual driving mode.

FIG. 16 is a diagram showing another example of speed variation when an automated driving mode is switched to a manual driving mode.

FIG. 17 is a diagram showing an example of a system configuration for sharing a skill level.

### DETAILED DESCRIPTION OF THE INVENTION

Hereinafter, embodiments of a vehicle control system, a vehicle control method and a vehicle control program of the present invention will be described with reference to the drawings.

### <Common Configuration>

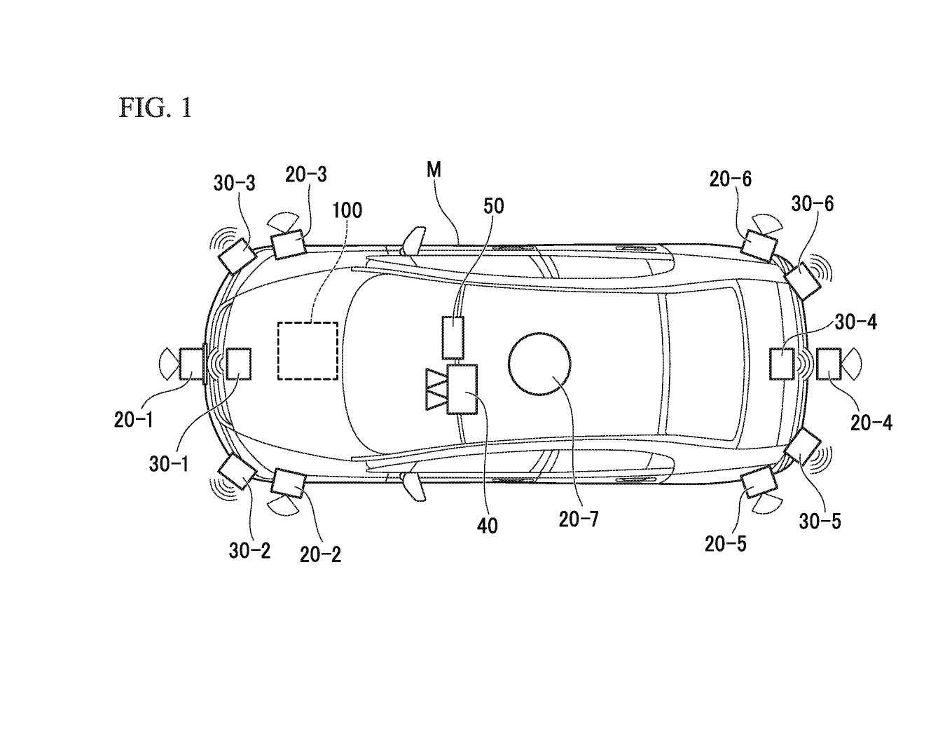

FIG. 1 is a diagram showing components of a vehicle (hereinafter referred to as a host vehicle M) equipped with a vehicle control system 100 of each embodiment. The vehicle equipped with the vehicle control system 100 is a two-wheeled, three-wheeled or four-wheeled car, for example, and includes a car having an internal combustion engine such as a diesel engine and a gasoline engine as a power source, an electric car having a motor as a power source, a hybrid car including both an internal combustion engine and a motor, etc. For example, the electric car is driven using power discharged from a battery such as a secondary cell, a hydrogen fuel cell, a metallic fuel cell and an alcohol fuel cell.

As shown in FIG. 1, the host vehicle M is equipped with sensors such as finders 20-1 to 20-7, radars 30-1 to 30-6 and a camera 40, a navigation device 50, and the vehicle control system 100.

For example, the finders 20-1 to 20-7 may use light detection and ranging (LIDAR) (or laser imaging detection and ranging) which measures scattered light with respect to radiated light to measure a distance to a target. For example, the finder 20-1 may be attached to a front grille or the like and the finders 20-2 and 20-3 may be attached to the sides of the car body, door mirrors, inside of headlights, regions near the side indicator lights, and the like. The finder 20-4 may be attached to a trunk lid or the like and the finders 20-5 and 20-6 may be attached to the sides of the car body, inside of taillights or the like. For example, the aforementioned finders 20-1 to 20-6 may have a detection area of about 150 degrees with respect to the horizontal direction. In addition, the finder 20-7 may be attached to a roof or the like. For example, the finder 20-7 may have a detection area of 360 degrees with respect to the horizontal direction.

For example, the radars 30-1 and 30-4 may be long-range millimeter-wave radars having a wider detection area in the depth direction than other radars. In addition, the radars 30-2, 30-3, 30-5 and 30-6 may be medium-range millimeter-wave radars having a narrower detection area in the depth direction than the radars 30-1 and 30-4.

Hereinafter, the finders 20-1 to 20-7 will be simply described as a “finder 20” when they are not particularly distinguished and the radars 30-1 to 30-6 will be simply described as a “radar 30” when they are not particularly distinguished. The radar 30 detects an object using a frequency modulated continuous wave (FM-CW) method, for example.

The camera 40 is a digital camera using an individual imaging device such as a charge coupled device (CCD) and a complementary metal oxide semiconductor (CMOS), for example. The camera 40 is attached to an upper portion of a front windshield, the rear side of an interior mirror, or the like. For example, the camera 40 periodically repeatedly captures an image in front of the host vehicle M. The camera 40 may be a stereo camera including a plurality of cameras.

Meanwhile, the components shown in FIG. 1 are exemplary and some of the components may be omitted or other components may be added.

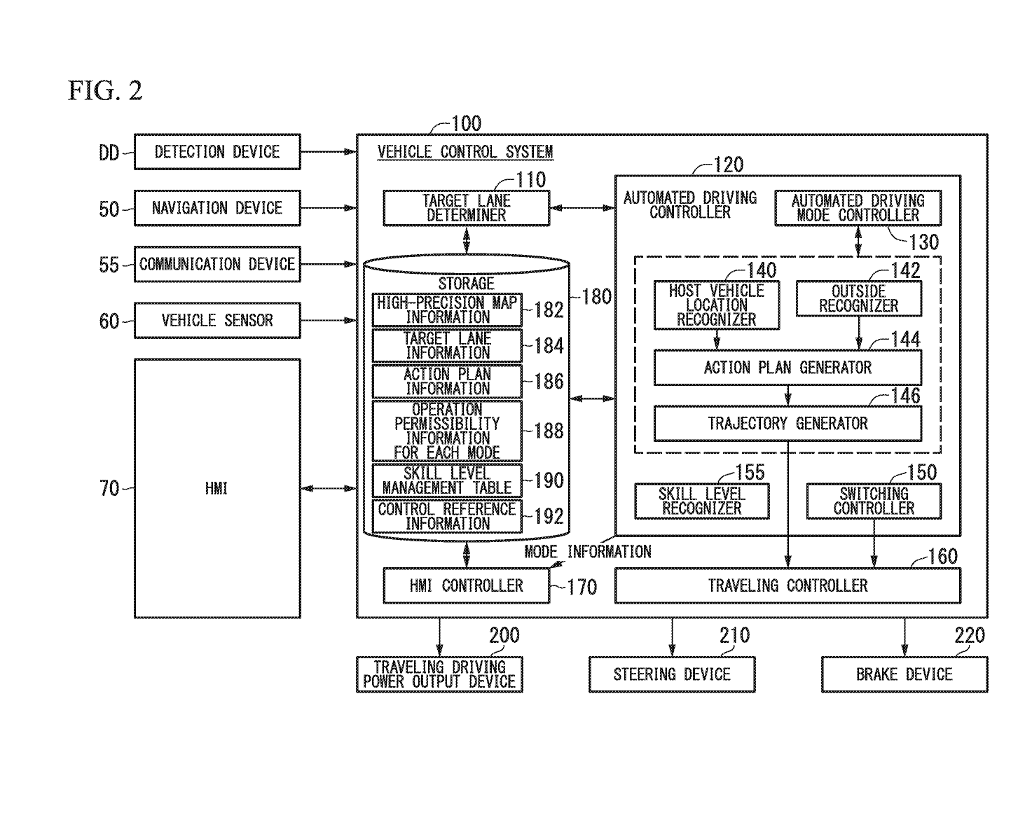

FIG. 2 is a diagram illustrating a functional configuration focusing on the vehicle control system 100. The host vehicle M is equipped with a detection device DD including the finder 20, the radar 30, the camera 40 and the like, the navigation device 50, a communication device 55, a vehicle sensor 60, a human machine interface (HMI) 70, the vehicle control system 100, a traveling driving power output device 200, a steering device 210 and a brake device 210. These devices and apparatuses are connected through a multi-communication line such as a controller area network (CAN) communication line, a serial communication line, a wireless communication network or the like. Meanwhile, the vehicle control system in the claims does not indicate only the “vehicle control system 100” and may include components (the detection unit DD, the HMI 70 and the like) in addition to the vehicle control system 100.

The navigation device 50 has a global navigation satellite system (GNSS) receiver, map information (navigation maps), a touch panel type display device serving as a user interface, a speaker, a microphone, etc. The navigation device 50 identifies a location of the host vehicle M through the GNSS receiver and derives a route from the location to a destination designated by a user. The route derived by the navigation device 50 is provided to a target lane determiner 110 of the vehicle control system 100. The location of the host vehicle M may be identified or complemented by an inertial navigation system (INS) using the output of the vehicle sensor 60. In addition, the navigation device 50 provides guidance for the route to the destination through voice and navigation display when the vehicle control system 100 operates in a manual driving mode. Meanwhile, a component for identifying the location of the host vehicle M may be installed independently of the navigation device 50. Further, the navigation device 50 may be realized according to a function of a terminal device such as a smartphone or a tablet terminal carried by the user, for example. In this case, transmission and reception of information are performed between the terminal device and the vehicle control system 100 through wireless or wired communication.

For example, the communication device 55 performs wireless communication using a cellular network, a Wi-Fi network, Bluetooth (registered trademark), dedicated short range communication (DSRC), laser communication and the like. A communication partner of the communication device 55 may be a communication device mounted in a surrounding vehicle or a server, a personal computer, a cellular phone or a tablet terminal connected to a network.

The vehicle sensor 60 includes a vehicle speed sensor which detects a vehicle speed, an acceleration sensor which detects an acceleration, a yaw rate sensor which detects an angular velocity around the vertical axis, an azimuth sensor which detects a direction of the host vehicle M, etc.

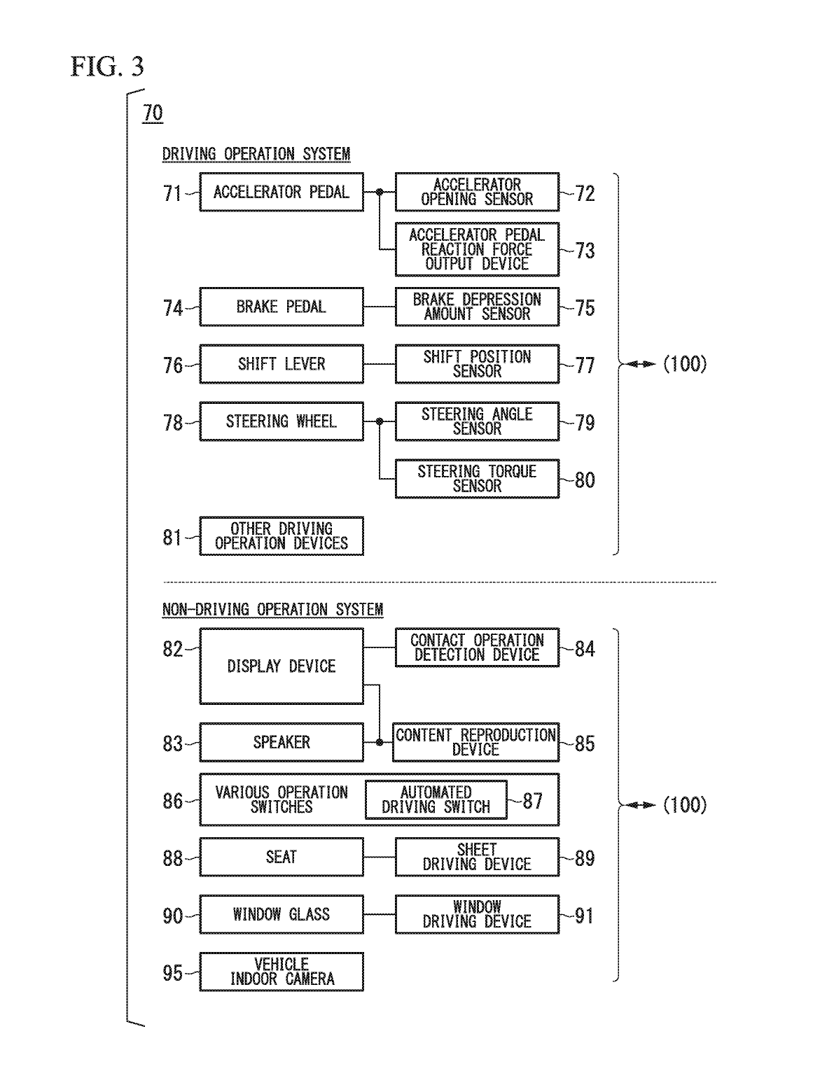

FIG. 3 is a block diagram of the HMI 70. The HMI 70 includes components of a driving operation system and components of a non-driving operation system, for example. The boundary between these systems is not clear and the components of a driving operation system may include a function of a non-driving operation system (or vice versa).

For example, the HMI 70 includes an accelerator pedal 71, an accelerator opening sensor 72, an accelerator pedal reaction force output device 73, a brake pedal 74, a brake depression amount sensor (or a master pressure sensor or the like) 75, a shift lever 76, a shift position sensor 77, a steering wheel 78, a steering angle sensor 79, a steering torque sensor 80, and other driving operation devices 81 as the components of the driving operation system.

The accelerator pedal 71 is an operator for receiving an acceleration instruction of a vehicle occupant (or a deceleration instruction according to a resetting operation). The accelerator opening sensor 72 detects a depression amount of the accelerator pedal 71 and outputs an accelerator opening signal indicating the depression amount to the vehicle control system 100. The accelerator opening signal may be directly output to the traveling driving power output device 200, the steering device 210 or the brake device 220 instead of being output to the vehicle control system 100. The same applies to components of other driving operation systems which will be described below. The accelerator pedal reaction force output device 73 outputs a force (operation reaction force) in a direction opposite to an operation direction for the accelerator pedal 71 according to an instruction from the vehicle control system 100, for example.

The brake pedal 74 is an operator for receiving a deceleration instruction of the vehicle occupant. The brake depression amount sensor 75 detects a depression amount (or depression force) of the brake pedal 74 and outputs a brake signal indicating the detection result to the vehicle control system 100.

The shift lever 76 is an operator for receiving a shift stage change instruction of the vehicle occupant. The shift position sensor 77 detects a shift stage instructed by the vehicle occupant and outputs a shift position signal indicating the detection result to the vehicle control system 100.

The steering wheel 78 is an operator for receiving a turning instruction of the vehicle occupant. The steering angle sensor 79 detects an operation angle of the steering wheel 78 and outputs a steering angle signal indicating the detection result to the vehicle control system 100. The steering torque sensor 80 detects a torque applied to the steering wheel 78 and outputs a steering torque signal indicating the detection result to the vehicle control system 100.

The other driving operation devices 81 are a joystick, a button, a dial switch, a graphical user interface (GUI) switch and the like, for example. The other driving operation devices 81 receive an acceleration instruction, a deceleration instruction, a turning instruction and the like and output the instructions to the vehicle control system 100.

The HMI 70 includes a display device 82, a speaker 83, a contact operation detection device 84, a content reproduction device 85, various operation switches 86, a seat 88, a seat driving device 89, a window glass 90, a window driving device 91, and a vehicle indoor camera 95 as is a component of the non-driving operation system, for example.

For example, the display device 82 is a liquid crystal display (LCD), an organic electroluminescence (EL) display device or the like attached to respective positions including an instrument panel, or facing an assistant driver's seat or a back seat. In addition, the display device 82 may be a head up display (HUD) which projects images to the front windshield and other windows. The speaker 83 outputs sound. The contact operation detection device 84 detects a contact position (touch position) on a display screen of the display device 82 and outputs the contact position to the vehicle control system 100 when the display device 82 is a touch panel. Further, the contact operation detection device 84 may be omitted when the display device 82 is not a touch panel.

The content reproduction device 85 includes a digital versatile disc (DVD) reproduction device, a compact disc (CD) reproduction device, a television receiver, a device for generating various guidance images and the like, for example. Some or all of the display device 82, the speaker 83, the contact operation detection device 84 and the content reproduction device 85 may be the same components as those of the navigation device 50.

The various operation switches 86 are disposed at any points inside of the vehicle. The various operation switches 86 include an automated driving switch 87 indicating starting (or future starting) and stopping of automated driving. The automated driving switch 87 may be either of a graphical user interface (GUI) switch or a mechanical switch. In addition, the various operation switches 86 may include switches for driving the seat driving device 89 and the window driving device 91.

The seat 88 is a seat on which a vehicle occupant sits. The seat driving device 89 freely drives a reclining angle, a position in a back-and-forth direction, a yaw angle and the like of the seat 88. The window glass 90 is attached to each door, for example. The window driving device 91 drives opening and closing of the window glass 90.

The vehicle indoor camera 95 is a digital camera using an individual image sensing element such as a CCD and a CMOS. The vehicle indoor camera 95 is attached to a position at which at least the head of a vehicle occupant performing a driving operation can be photographed, such as a rear-view mirror, a steering boss or an installment panel. For example, the camera 40 periodically and repeatedly photographs the vehicle occupant.

Prior to description of the vehicle control system 100, the traveling driving power output device 200, the steering device 210 and the brake device 220 will be described.

The traveling driving power output device 200 outputs traveling driving power (torque) for traveling of a vehicle M to driving wheels. For example, the traveling driving power output device 200 includes an engine, a transmission and an engine electronic controller (ECU) for controlling the engine when the host vehicle M is a car having an internal combustion engine as a power source, includes a drive motor and a motor ECU for controlling the drive motor when the host vehicle M is an electric car having an electric motor as a power source, and includes an engine, a transmission, an engine ECU, a drive motor and a motor ECU when the host vehicle M is a hybrid car. When the traveling driving power output device 200 includes only an engine, the engine ECU adjusts a throttle opening and a shift stage of the engine, and the like according to information input from the traveling controller 160 which will be described later. When the traveling driving power output device 200 includes only a drive motor, the motor ECU adjusts a duty ratio of a PWM signal applied to the drive motor according to information input from the traveling controller 160. When the traveling driving power output device 200 includes an engine and a drive motor, the engine ECU and the motor ECU control traveling driving power in cooperation according to information input from the traveling controller 160.

The steering device 210 includes a steering ECU and an electric motor, for example. The electric motor applies a force acting on a rack and piston mechanism to change a steering direction of the wheels, for example. The steering ECU drives the electric motor according to information input from the vehicle control system 100 or input information on a steering angle or a steering torque to change the steering direction of the wheels.

The brake device 220 is an electric servo brake device including a brake caliper, a cylinder which transfers hydraulic pressure to the brake caliper, an electric motor which generates hydraulic pressure in the cylinder, and a brake controller, for example. The brake controller of the electric servo brake device controls the electric motor according to information input from the traveling controller 160 such that a brake torque according to a braking operation is output to each wheel. The electric servo brake device may include a mechanism for transferring hydraulic pressure generated according to operation of the brake pedal to the cylinder through a master cylinder as a backup. Further, the brake device 220 is not limited to the aforementioned electric servo brake device and may be an electronically controlled hydraulic brake device. The electronically controlled hydraulic brake device controls an actuator according to information input from the traveling controller 160 to transfer hydraulic pressure of the master cylinder to the cylinder. In addition, the brake device 220 may include a regeneration brake according to a drive motor which may be included in the traveling driving power output device 200.

### [Vehicle Control System]

Hereinafter, the vehicle control system 100 will be described. For example, the vehicle control system 100 is realized by one or more processors or hardware having equivalent functions. The vehicle control system 100 may be composed of a combination of a processor such as a central processing unit (CPU), a storage device, and an electric controller (ECU) to which a communication interface is connected through an internal bus or a micro-processing unit (MPU).

Referring back to FIG. 2, the vehicle control system 110 includes a target lane determiner 110, an automated driving controller 120, the traveling controller 160 and a storage 180, for example. The automated driving controller 120 includes an automated driving mode controller 130, a host vehicle location recognizer 140, an outside recognizer 142, an action plan generator 144, a trajectory generator 146, and a switching controller 150, for example. Some or all of the target lane determiner 110, each part of the automated driving controller 120 and the traveling controller 160 are realized by a processor executing programs (software). In addition, some or all of these components may be realized by hardware such as a large scale integration (LSI) and an application specific integrated circuits (ASICs) or realized by a combination of software and hardware.

For example, the storage 180 stores information such as high-precision map information 182, target lane information 184, action plan information 186, operation permissibility information 188 for each mode, a skill level management table 190, and control reference information 192. The storage 180 is realized by a read only memory (ROM), a random access memory (RAM), a hard disk drive (HDD), a flash memory or the like. The programs executed by processor may be stored in the storage 180 in advance or downloaded from an external device through Internet equipment mounted on the vehicle or the like. Further, the programs may be installed in the storage 180 by mounting a portable storage medium in which the programs are stored in a drive device that is not shown. Furthermore, the vehicle control system 100 may be distributed by a plurality of computer devices.

The target lane determiner 110 is realized by an MPU, for example. The target lane determiner 110 divides a route provided by the navigation device 50 into a plurality of blocks (divides the route by 100 [m] in a vehicle traveling direction, for example) and determines a target lane for each block with reference to the high-precision map information 182. For example, the target lane determiner 110 performs determination of how many lanes are present next to a traveling lane from the left. For example, when the route includes a branch point, a merging point or the like, the target lane determiner 110 determines a target lane such that the host vehicle M is able to travel a reasonable traveling route for traveling to a branch destination. The target lane determined by the target lane determiner 110 is stored as the target lane information 184 in the storage 180.

The high-precision map information 182 is map information having higher precision than a navigation map included in the navigation device 50. For example, the high-precision map information 182 includes information on centers of lanes, information on boundaries of lanes or the like. In addition, the high-precision map information 182 may include road information, traffic regulation information, address information (addresses and zip codes), facility information, telephone number information and the like. The road information includes information representing road types such as an expressway, a toll road, a national highway and a prefectural road and information such as the number of lanes of a road, the width of each lane, road slopes, locations of roads (three-dimensional coordinates including longitude, latitude and height), curvatures of curves of lanes, locations of merging and branch points of lanes, and signs provided on roads. The traffic regulation information includes information representing blocking of a lane due to a construction, a traffic accident, a traffic jam or the like.

The automated driving mode controller 130 determines a mode of automated driving performed by the automated driving controller 120. Automated driving modes in the present embodiment include modes below. The modes below are merely an example and the number of automated driving modes may be arbitrarily determined.

### [Mode A]

Mode A is a mode having the highest automated driving degree. When mode A is implemented, all vehicle controls such as complicated merging control are automatically performed and thus a vehicle occupant need not monitor the surrounds and state of the host vehicle M.

### [Mode B]

Mode B is a mode having a second highest automated driving degree following mode A. When mode B is implemented, all vehicle controls are automatically performed in general, driving operation of the host vehicle M is left to the vehicle occupant according to situation. Accordingly, the vehicle occupant needs to monitor the surroundings and state of the host vehicle M.

### [Mode C]

Mode C is a mode having a third highest automated driving degree following mode B. When mode C is implemented, the vehicle occupant needs to perform a checking operation on the HMI 70 according to situation. In mode C, for example, when the vehicle occupant is notified of a lane change timing and performs an operation of instructing lane change on the HMI 70, automatic lane change is performed. Accordingly, the vehicle occupant needs to monitor the surroundings and state of the host vehicle M.

The automated driving mode controller 130 determines an automated driving mode on the basis of an operation of the vehicle occupant performed on the HMI 70, an event determined by the action plan generator 144, a traveling state determined by the trajectory generator 146 and the like. The HMI controller 170 is notified of the automated driving mode. Further, a limit according to the performance of the detection device DD of the host vehicle M and the like may be set in the automated driving modes. For example, when the performance of the detection device DD is low, mode A may not be implemented. Any mode may switch (override) to a manual driving mode according to an operation performed on a component of the driving operation system in the HMI 70.

Furthermore, the automated driving mode controller 130 controls a degree of change in modes including automated driving and manual driving on the basis of a skill level of the vehicle occupant recognized by the skill level recognizer 155. This will be described later.

The host vehicle location recognizer 140 of the automated driving controller 120 recognizes a lane (traveling lane) in which the host vehicle M is traveling and a relative location of the host vehicle M with respect to the traveling lane on the basis of the high-precision map information 182 stored in the storage 180 and information input from the finder 20, the radar 30, the camera 40, the navigation device 50 or the vehicle sensor 60.

For example, the host vehicle location recognizer 140 recognizes the traveling lane by comparing a road division line pattern (e.g., arrangement of solid lines and broken lines) recognized from the high-precision map information 182 with a road division line pattern around the host vehicle M, recognized from an image captured by the camera 40. In such recognition, the location of the host vehicle M acquired from the navigation device 50 and a processing result of the INS may be added.

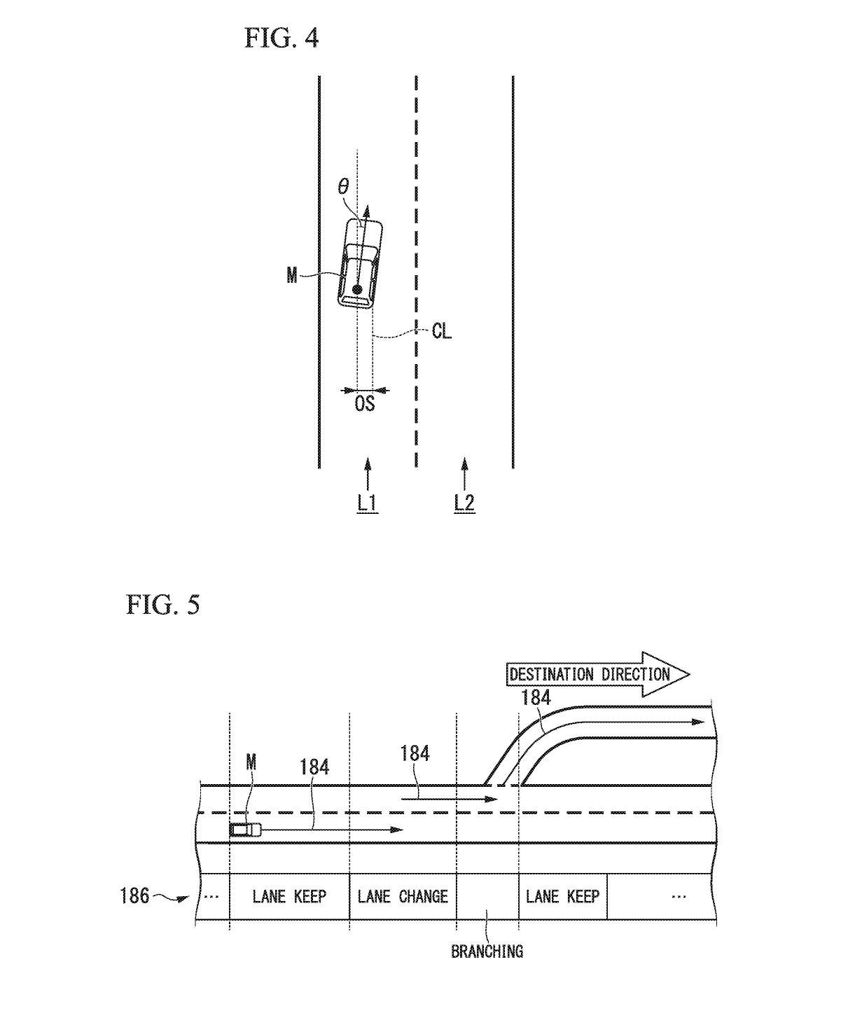

FIG. 4 is a diagram showing a state in which the host vehicle location recognizer 140 recognizes a relative location of the host vehicle M with respect to a traveling lane L1. For example, the host vehicle location recognizer 140 recognizes a gap OS between a reference point (e.g., the center of gravity) of the host vehicle M and a traveling lane center CL, and an angle θ of the direction of travel of the host vehicle M to a line connecting the traveling lane center CL as a relative location of the host vehicle M with respect to the traveling lane L1. Alternatively, the host vehicle location recognizer 140 may recognize the location of the reference point of the host vehicle M with respect to any one of side edges of the host lane L1, or the like as a relative location of the host vehicle M with respect to the traveling lane. The relative location of the host vehicle M recognized by the host vehicle location recognizer 140 is provided to the traveling lane determiner 110.

The outside recognizer 142 recognizes states such as locations, speeds and accelerations of surrounding vehicles on the basis of information input from the finder 20, the radar 30, the camera 40 and the like. For example, a surrounding vehicle is a vehicle traveling around the host vehicle M in the same direction as the direction in which the host vehicle M is traveling. A location of a surrounding vehicle may be indicated by a representative point such as the center of gravity or a corner of the surrounding vehicle or a region represented as an outline of the surrounding vehicle. A “state” of a surrounding vehicle may include the acceleration of the surrounding vehicle, and whether the lane thereof is being changed (or whether lane change is intended) recognized on the basis of information on the above-described various devices. In addition, the outside recognizer 142 may recognize locations of guardrails, telegraph poles, parked vehicles, pedestrians and other objects in addition to surrounding vehicles.

The action plan generator 144 sets a start point of automated driving and/or a destination of automated driving. The start point of automated driving may be a current location of the host vehicle M or a point on which an operation of instructing automated driving is performed. The action plan generator 144 generates an action plan in a section between the start point and the destination of automated driving. Further, the present invention is not limited thereto and the action plan generator 144 may generate an action plan with respect to any section.

An action plan is composed of a plurality of sequentially executed events, for example. For example, events include a deceleration event of reducing the speed of the host vehicle M, an acceleration event of increasing the speed of the host vehicle M, a lane keep event of causing the host vehicle M to travel without leaving a traveling lane, a lane change event of changing traveling lanes, a passing event of causing the host vehicle M to pass a preceding vehicle, a branching event of changing lanes to a desired lane at a branching point or causing the host vehicle M to travel without leaving the current traveling lane, a merging event of increasing or decreasing the speed of the host vehicle M on a merging lane to merge into a main line and changing traveling lanes, a handover event of switching a manual driving mode to an automated driving mode at a start point of automated driving or switching an automated driving mode to a manual driving mode at a scheduled end point of automated driving, and the like. The action plan generator 144 sets a lane change event, a branching event or a merging event at a position at which a target lane determined by the target lane determiner 110 is switched. Information representing an action plan generated by the action plan generator 144 is stored in the storage 180 as the action plan information 186.

FIG. 5 is a diagram showing an example of an action plan generated in a certain section. As shown, the action plan generator 144 generates an action plan necessary for the host vehicle M to travel in a target lane indicated by the target lane information 184. Further, the action plan generator 144 may dynamically change an action plan according to change in the situation of the host vehicle M irrespective of the target lane information 184. For example, when the speed of a surrounding vehicle recognized by the outside recognizer 142 exceeds a threshold value during vehicle traveling or a surrounding vehicle traveling in a lane adjacent to the host lane moves in the direction of the host lane, the action plan generator 144 changes an event set for a driving section in which the host vehicle M will travel. For example, in a case in which events are set such that a lane change event is executed after a lane keep event, when it is confirmed that the vehicle has progressed at a speed equal to or greater than a threshold value after a lane to be changed to during the lane keep event according to a recognition result of the outside recognizer 142, the action plan generator 144 may change the event following the lane keep event from the lane change event to a deceleration event, a lane keep event or the like. As a result, the vehicle control system 100 can cause the host vehicle M to automatically travel safely even when an environment state changes.

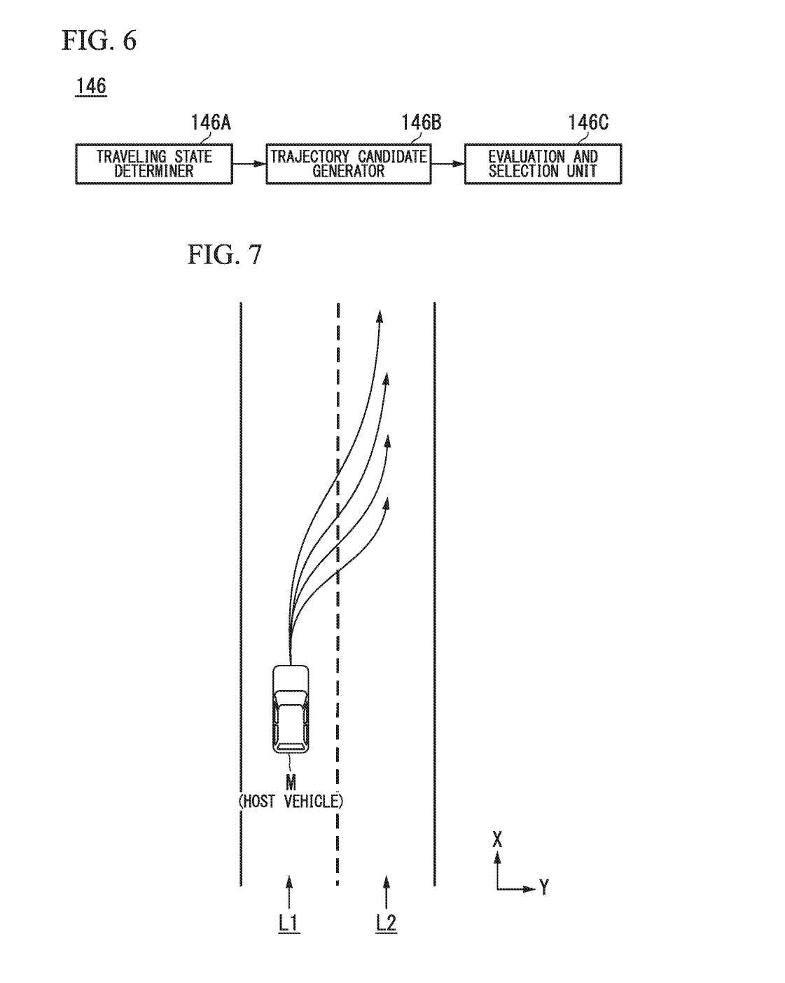

FIG. 6 is a diagram showing an example of a configuration of the trajectory generator 146. For example, the trajectory generator 146 includes a traveling state determiner 146A, a trajectory candidate generator 146B and an evaluation and selection unit 146C.

For example, the traveling state determiner 146A determines any traveling state of constant-speed traveling, following traveling, low-speed following traveling, deceleration traveling, curve traveling, obstacle avoiding traveling and the like when a lane keep event is performed. In this case, the traveling state determiner 146A determines a traveling state as constant-speed traveling when there are no surrounding vehicles in front of the host vehicle M. In addition, the traveling state determiner 146A determines a traveling state as following travel when following traveling is intended with respect to a preceding vehicle. Further, the traveling state determiner 146A determines a traveling state as low-speed following traveling in a traffic jam situation and the like. Further, the traveling state determiner 146A determines a traveling state as deceleration traveling when the outside recognizer 142 recognizes deceleration of a preceding vehicle or an event such as vehicle stopping, vehicle parking or the like is performed. Further, the traveling state determiner 146A determines a traveling state as curve traveling when the outside recognizer 142 recognizes that the host vehicle M comes close to a curved road. In addition, the traveling state determiner 146A determines a traveling state as obstacle avoiding traveling when the outside recognizer 142 recognizes an obstacle in front of the host vehicle M. Further, when a lane change event, a passing event, a branching event, a merging event, a handover event and the like are performed, the traveling state determiner 146A determines traveling states in response to the respective events.

The trajectory candidate generator 146B generates trajectory candidates on the basis of a traveling state determined by the traveling state determiner 146A. FIG. 7 is a diagram showing an example of trajectory candidates generated by the trajectory candidate generator 146B. FIG. 7 shows trajectory candidates generated when the host vehicle M changes lanes from a lane L1 to a lane L2.

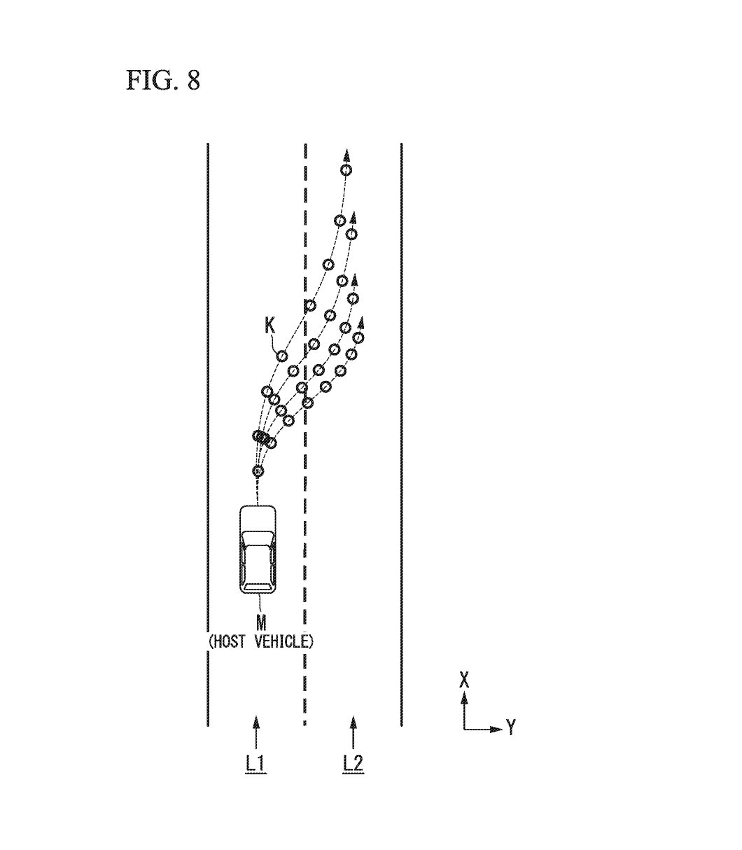

For example, the trajectory generator 146B determines trajectories as show in FIG. 7 as a group of target locations (trajectory points K) at which a reference position (e.g., the center of gravity or the rear wheel shaft center) of the host vehicle M will arrive for each predetermined time in the future. FIG. 8 is a diagram representing trajectory candidates generated by the trajectory candidate generator 146B as trajectory points K. The speed of the host vehicle M increases as the interval of the trajectory points K becomes wider and the speed of the host vehicle M decreases as the interval of the trajectory points K becomes narrower. Accordingly, the trajectory generator 146B gradually increases the interval of the trajectory points K when the speed needs to be increased and gradually decreases the interval of the trajectory points when the speed needs to be decreased.

In this manner, the trajectory points K include a speed component and thus the trajectory generator 146B needs to provide a target speed for each of the trajectory points K. A target speed is determined in response to a traveling state determined by the traveling state determiner 146A.

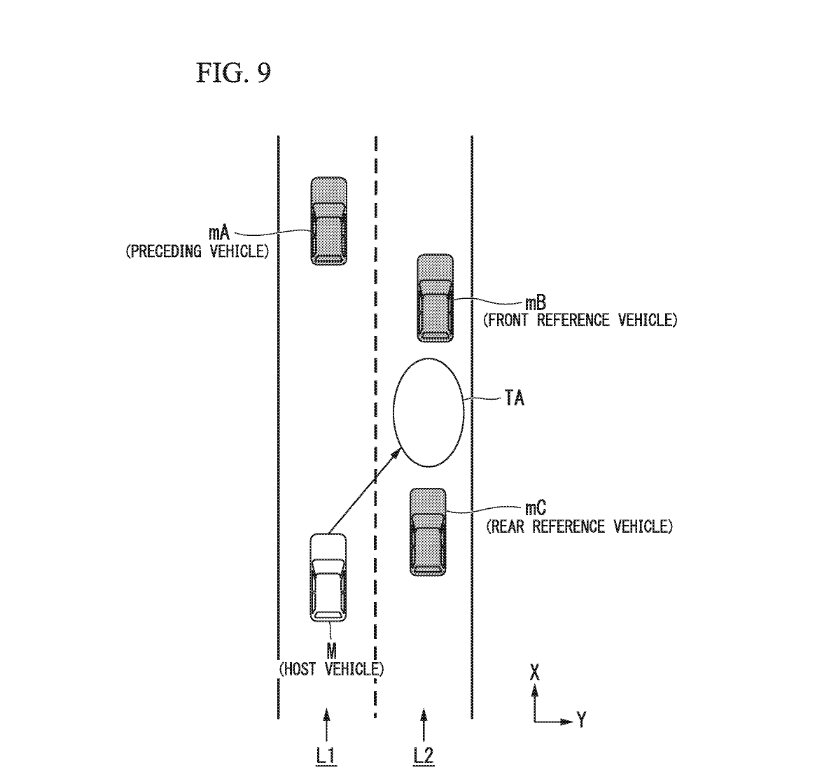

Here, a method of determining a target speed when lane change (including branching) is performed will be described. First, the trajectory generator 146B sets a lane change target location (or a merging target location). The lane change target position is set as a relative location with respect to a surrounding vehicle and determines “a surrounding vehicle for which lane change will be performed.” The trajectory generator 146B sets a target speed when lane change is performed focusing on three surrounding vehicles on the basis of the lane change target location. FIG. 9 is a diagram showing a lane change target location TA. In the figure, L1 represents a host lane and L2 represents a neighboring lane. Here, a surrounding vehicle traveling immediately before the host vehicle M in the same lane as the host vehicle M is defined as a preceding vehicle mA, a surrounding vehicle traveling immediately before the lane change target location TA is defined as a front reference vehicle mB, and a surrounding vehicle traveling immediately after the lane change target location TA is defined as a rear reference vehicle mC. Although the host vehicle M needs to increase or decrease the speed in order to move to the side of the lane change target location TA, the host vehicle M should avoid catching up with the preceding vehicle mA at that time. Accordingly, the trajectory generator 146B predicts future states of the three surrounding vehicles and determines a target speed such that the host vehicle does not interfere with each surrounding vehicle.

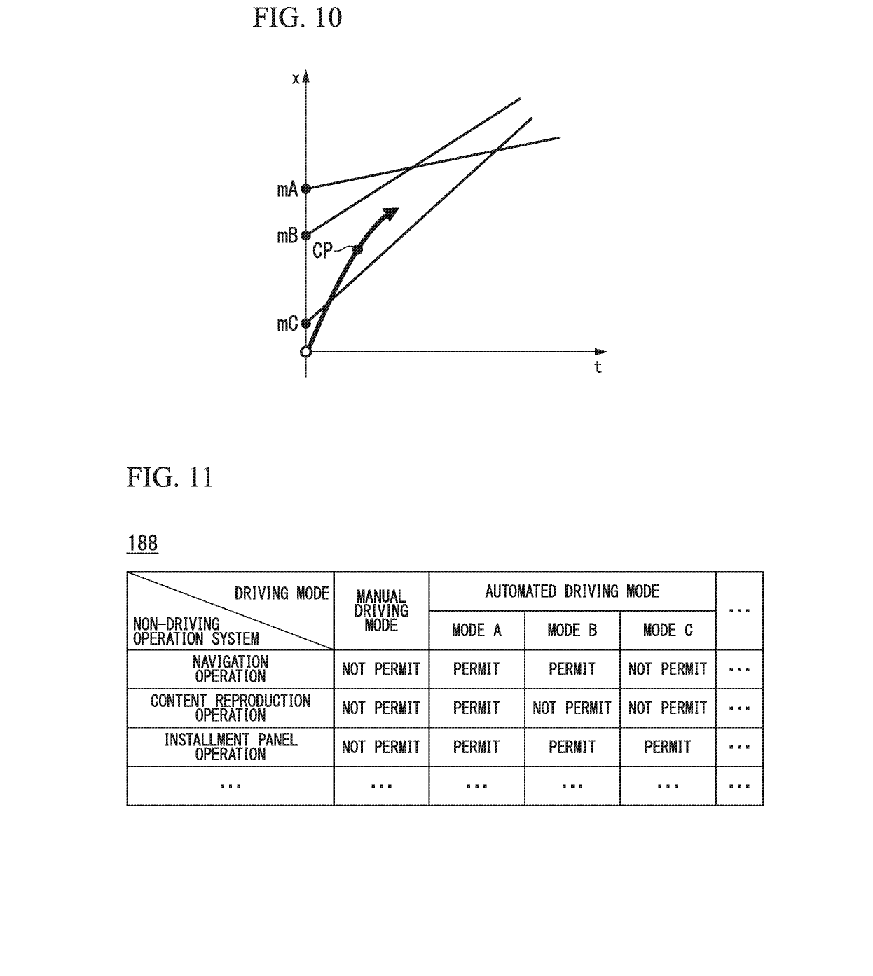

FIG. 10 is a diagram showing a speed generation model when speeds of three surrounding vehicles are assumed to be constant. In the figure, straight lines extending from mA, mB and mC represent displacements in a travel direction when the respective surrounding vehicles are assumed to travel at a constant speed. The host vehicle M should be located between the front reference vehicle mB and the rear reference vehicle mC at a point CP at which lane change is completed and located after the preceding vehicle mA before the point CP. Under such restrictions, the trajectory generator 146B derives a plurality of time series patterns of a target speed until lane change is completed. In addition, a plurality of trajectory candidates as shown in FIG. 8 are derived by applying the time series patterns of the target speed to a model such as a spline curve. Further, motion patterns of the three surrounding vehicles are not limited to a constant speed as shown in FIG. 10 and may be predicted on the premise that an acceleration is constant and a jerk is constant.

The evaluation and selection unit 146C evaluates trajectory candidates generated by the trajectory candidate generator 146B from the viewpoint of planning and safety, for example, and selects a trajectory to be output to the traveling controller 160. From the viewpoint of planning, for example, a trajectory is evaluated high when followability for a plane (e.g., action plan) which has already been generated is high and the entire length of the trajectory is short. For example, when lane change to the right is desired, a trajectory through which lane change to the left is performed and then returned is evaluated low. From the viewpoint of safety, for example, as a distance between the host vehicle M and an object (surrounding vehicle or the like) increases and variations in an acceleration/deceleration and a steering angle, and the like decreases at each trajectory point, a corresponding trajectory is evaluated higher.

The switching controller 150 switches between an automated driving mode and a manual driving mode on the basis of a signal input from the automated driving switch 87. In addition, the switching controller 150 switches from an automated driving mode to a manual driving mode on the basis of an operation of instructing acceleration, deceleration or steering for a component of the driving operation system in the HMI 70. For example, the switching controller 150 switches from an automated driving mode to a manual driving mode (override) when a state in which an operation quantity indicated by a signal input from a component of the driving operation system in the HMI 70 exceeds a threshold value continues for a reference time or longer. In addition, when an operation for a component of the driving operation system in the HMI 70 is not detected for a predetermined time after switching to the manual driving mode according to overriding, the switching controller 150 may return the driving mode to the automated driving mode.

The skill level recognizer 155 recognizes a skill level of a vehicle occupant (a vehicle occupant performing an operation pertaining to driving when manual driving or automated driving requiring an operation is performed, typically, a vehicle occupant seating on a driver's seat at which the steering wheel 78 is provided). This will be described later.

The traveling controller 160 controls the traveling driving power output device 200, the steering device 210 and the brake device 220 such that the host vehicle M passes through the trajectory generated by the trajectory generator 146 at a scheduled time.

The HMI controller 170 controls the HMI 70 according to automated driving mode type with reference to the operation permissibility information 188 of each mode when information on an automated driving mode is notified of by the automated driving controller 120.

FIG. 11 is a diagram showing an example of the operation permissibility information 188 for each mode. The operation permissibility information 188 for each mode shown in FIG. 11 has a “manual driving mode” and an “automated driving mode” as items of driving modes. In addition, it has the aforementioned “mode A,” “mode B,” “mode C” and the like as the “automated driving mode.” Further, the operation permissibility information 188 for each mode has a “navigation operation” which is an operation for the navigation device 50, a “content reproduction operation” which is an operation for the content reproduction device 85, an “installment panel operation” which is an operation for the display device 82, and the like as items of the non-driving operation system. Although permissibility of an operation of a vehicle occupant for the non-driving operation system is set for each of the aforementioned driving modes in the example of the operation permissibility information 188 for each mode shown in FIG. 11, interface devices which are objects are not limited thereto.

The HMI controller 170 determines devices (one or both of the navigation device 50 and the HMI 70) permitted to be used and devices which are not permitted to be used by referring to the operation permissibility information 188 for each mode on the basis of mode information acquired from the automated driving controller 120. In addition, the HMI controller 170 controls permissibility of reception of an operation from the vehicle occupant for the HMI 70 or the navigation device 50 of the non-driving operation system on the basis of the determination result.

For example, when a driving mode implemented by the vehicle control system 100 is a manual driving mode, the vehicle occupant operates the driving operation system (e.g., accelerator pedal 71, the brake pedal 74, the shift lever 76, the steering wheel 78 and the like) of the HMI 70. Further, when a driving mode implemented by the vehicle control system 100 is mode B, mode C or the like which is an automated driving mode, a duty to monitor the surroundings of the host vehicle M is generated for the vehicle occupant. In such a case, in order to prevent the vehicle occupant from distraction due to actions other than driving (e.g., operation of the HMI 70 and the like) of the vehicle occupant (driver distraction), the HMI controller 170 performs control such that operations for the entire or part of the non-driving operation system of the HMI 70 are not received. Here, to cause the host vehicle M to monitor the surroundings, the HMI controller 170 may cause the display device 82 to display presence of a surrounding vehicle of the host vehicle M recognized by the outside recognizer 142 and the state of the surrounding vehicle through an image or the like and cause the HMI 70 to receive an confirmation operation according to the situation of the host vehicle M during traveling.

In addition, when the driving mode is automated driving mode A, the HMI controller 170 relieves regulations of driver distraction and performs control of receiving operations of the vehicle occupant for the non-driving operation system for which operations have not been received. For example, the HMI controller 170 causes the display device 82 to display a video, causes the speaker 83 to output sound or causes the content reproduction device 85 to reproduce content from a DVD. Meanwhile, content reproduced by the content reproduction device 85 may include entertainment such as television programs, various types of content pertaining to entertainment, for example, in addition to content stored in DVDs. Further, “content reproduction operation” shown in FIG. 11 may refer to a content operation with respect to such entertainment.

### [Mode Control Based on Skill Level]

Hereinafter, mode control based on a skill level recognized by the skill level recognizer 155 will be described. For example, the skill level recognizer 155 identifies a vehicle occupant on the basis of an image captured by the vehicle indoor camera 95 and recognizes a skill level for each vehicle occupant. For example the skill level recognizer 155 stores feature quantities of images in the storage 180 and determines that the vehicle occupant is the same person as a vehicle occupant (vehicle occupant photographed by the vehicle indoor camera 95 in the past) with respect to a feature quantity stored in the storage 180 when a feature quantity of the image is similar to the stored feature quantity.

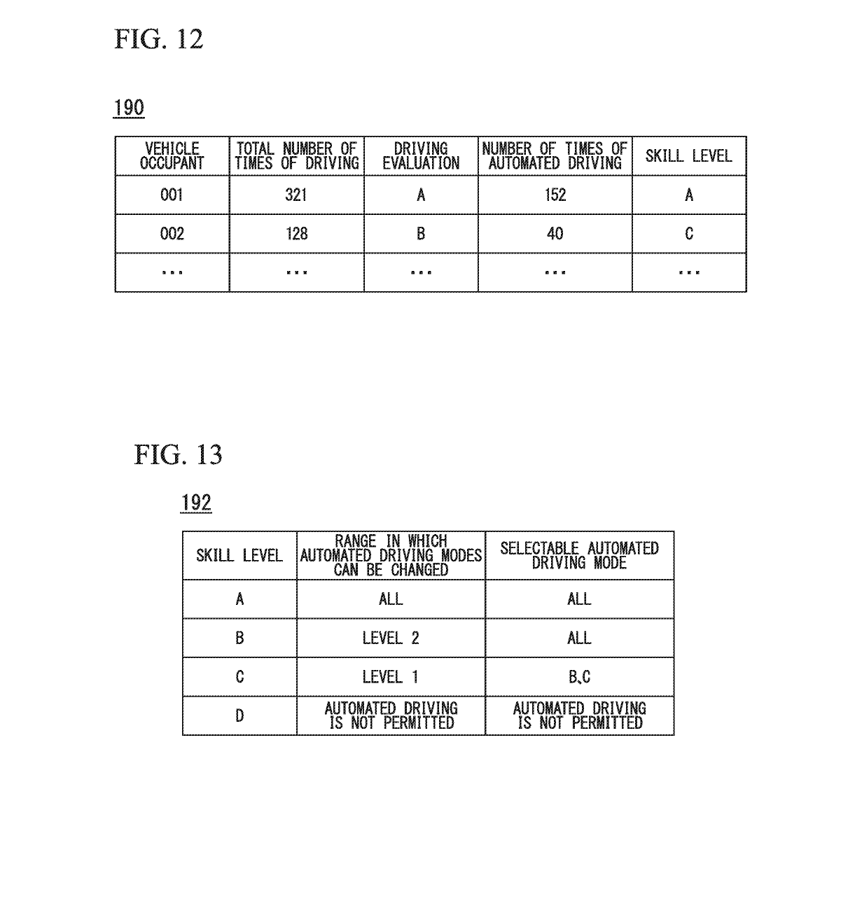

In addition, the skill level recognizer 155 recognizes a skill level on the basis of a total number of times of driving, driving evaluation in manual driving, the number of times of automated driving, and the like. FIG. 12 is a diagram showing an example of contents of a skill level management table 190 managed by the skill level recognizer 155. As shown, the skill level management table 190 is information in which total numbers of times of driving, driving evaluation, the numbers of times of automated driving and skill levels derived from such information are correlated for identified vehicle occupants.

A total number of times of driving is the number of times the host vehicle M is manually driven in a state a corresponding vehicle occupant sits on the driver's seat. The driving evaluation is a result of evaluation performed by the skill level recognizer 155 for a vehicle behavior (acceleration, deceleration, yaw rate or the like) when a corresponding vehicle occupant performs manual driving, for example. For example, the skill level recognizer 155 performs driving evaluation through a method of counting the number of times accelerations, decelerations or yaw rates which exceeds a threshold value has occurred and lowering driving evaluation when the number of times exceeds a reference value within a predetermined period. The number of times of automated driving is the number of times automated driving of the host vehicle M is performed in a state in which a corresponding vehicle occupant sits on the driver's seat. Since switching from manual driving to automated driving and switching from automated driving to manual driving are expected to occur before and after automated driving, the number of times of automated driving may be regarded as the number of times such switching has been experienced.

The skill level recognizer 155 integrally judges the aforementioned information to recognize a skill level of each vehicle occupant. For example, the skill level recognizer 155 derives a skill level by assigning weights to the aforementioned information and obtaining a weighted sum. Further, skill levels may not be one type and may be divided into skill levels of manual driving and skill levels of automated driving and recognized.

The automated driving mode controller 130 acquires a skill level of a vehicle occupant sitting on the driver's seat (a result of identification of the vehicle occupant is acquired from the skill level recognizer 155) from the skill level management table 190 and controls degrees of changes in modes including automated driving and manual driving on the basis of the control reference information 192. FIG. 13 is a diagram showing an example of contents of the control reference information 192. As shown, the control reference information 192 is information in which a range in which automated driving modes can be changed and a selectable automated driving mode are correlated with respect to skill levels.

When the range in which automated driving modes can be changed is “level 1,” modes which can be changed at a time are limited to manual driving mode-to-mode C (or vice versa; the same applies to the following), mode C-to-mode B and mode B-to-mode A. When the range in which automated driving modes can be changed is “level 2,” modes which can be changed at a time are extended to manual driving mode-to-mode C or mode B (or vice versa; the same applies to the following), mode C-to-mode B or mode A and mode B-to-mode A. When the range in which automated driving modes can be changed is “all,” changes between all modes are permitted.

In the example of FIG. 13, both the range in which automated driving modes can be changed and the selectable automated driving mode are set to “all” in the case of skill level A (highest). The range in which automated driving modes can be changed is set to “level 2” and the selectable automated driving mode is set to “all” in the case of skill level B (second highest following A). The range in which automated driving modes can be changed is set to “level 1” and the selectable automated driving mode is set to “mode B and mode C” in the case of skill level C (third highest following B). In the case of skill level D (lowest), execution of automated driving modes is not permitted.

By setting a restriction in this manner, it is possible to reduce changes in driving operational load between modes for a vehicle occupant having a low skill level. Particularly, such restriction considers a possibility that a vehicle occupant needs to quickly perform a driving operation and thus is fluster when a mode having a high degree of automated driving switches to a mode having a low degree of automated driving (including the manual driving mode). Accordingly, it is possible to limit changes in operational load to a degree of change that the vehicle occupant can cope with.

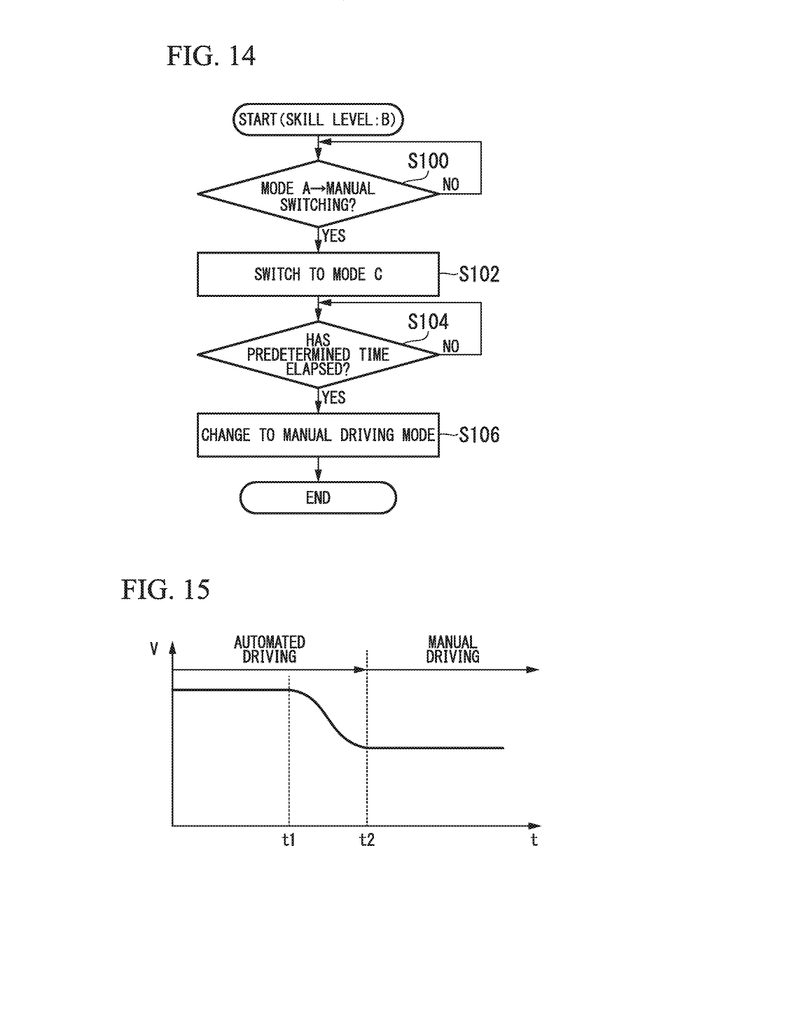

When a difference between degrees of automated driving before and after mode change is limited, the automated driving mode controller 130 may sequentially change modes within a limited range. FIG. 14 is a flowchart showing an example of a flow of a process executed by the automated driving mode controller 130. The process of this flowchart shows an example of a flow of a process executed when a skill level of a vehicle occupant is B. First, the automated driving mode controller 130 waits until mode A needs to be switched to the manual driving mode for any reason (step S100). When mode A needs to be switched to the manual driving mode, the automated driving mode controller 130 changes the mode A to mode C (step S102). This is because switching from mode A to the manual driving mode corresponds to “level 3” which is a range of change that is not performed for vehicle occupants having skill level B. Accordingly, the automated driving mode controller 130 waits until a predetermined time elapses (step S104) and changes mode C to the manual driving mode (step S106). Further, mode A may be changed to mode B instead of mode C in step S102. Further, “predetermined time elapses” may be replaced by “travels by a predetermined distance.”

When a degree of automated driving increases, the process of sequentially changing modes may also be performed in the same manner. In addition, when it is necessary to switch mode A to manual driving mode with respect to a vehicle occupant having skill level C, for example, a process of changing mode A to mode B, waiting until a predetermined time elapses, changing mode B to mode C, further waiting until the predetermined time elapses and changing mode C to the manual driving mode may be performed.

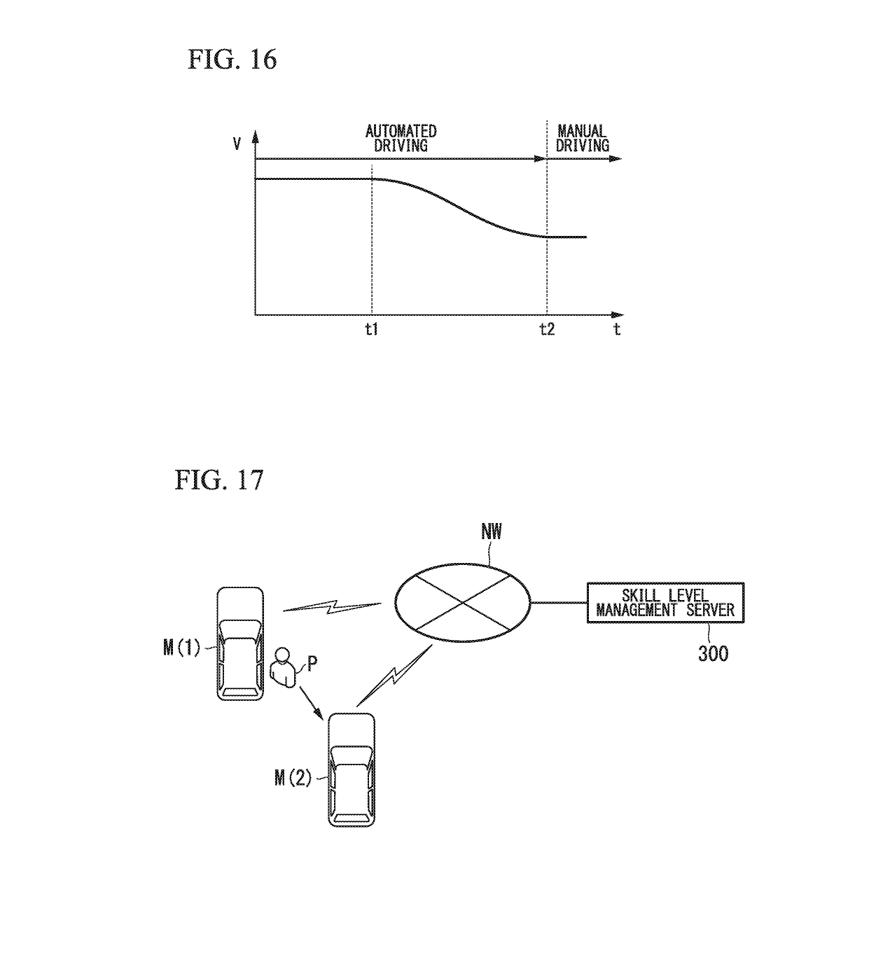

In addition, the automated driving mode controller 130 may increase a time or a traveling distance necessary for mode change as a skill level recognized by the skill level recognizer 155 decreases. FIG. 15 and FIG. 16 are diagrams showing examples of speed variations when an automated driving mode switches to the manual driving mode. In these figures, it is assumed that the speed is reduced to a predetermined speed (e.g., 60 [km/h]) and then switching is performed when the automated driving mode is switched to the manual driving mode. Further, the example of FIG. 15 shows speed variation realized in the case of a vehicle occupant having a higher skill level compared to the example of FIG. 16. As shown, a period from a time t1 at which control of switching from automated driving to manual driving is started to a time t2 at which the automated driving has switched to manual driving is longer in the case of a vehicle occupant having a lower skill level.

In addition, the automated driving controller 120 may change a behavior of the host vehicle M when the automated driving mode is ended and the manual driving mode is implemented on the basis of a skill level recognized by the skill level recognizer 155. For example, when the above-described control of “reducing the predetermined speed” is performed, the trajectory generator 146 of the automated driving controller 120 determines future speed variation of the host vehicle M on the basis of a jerk uniformity model represented by equation (1), for example.

V(t)=v(0)+a(0)·t+(½·J·t²) (1)

In equation (1), v(0) is the speed of the host vehicle M at current time t(0), a(0) is the acceleration of the host vehicle M at current time t(0), J is a jerk. Speed variation in some or all of sections in which speed reduction control is performed is determined according to this equation. Here, the trajectory generator 146 alleviates speed variation by reducing a jerk given as a constant when a skill level is low. In addition, the trajectory generator 146 may determine speed variation by applying an acceleration uniformity model without limiting to the jerk uniformity model and, in such a case, alleviates speed variation by reducing an acceleration given as a constant when a skill level is low.

Although the skill level recognizer 155 may complete the process inside of the host vehicle M, it may be possible to sharing a skill level between vehicles by communicating with an external device when a certain vehicle occupant rides in and drives a plurality of vehicles. FIG. 17 is a diagram showing an example of a system configuration for sharing a skill level. In this system, a plurality of vehicles M(1) and M(2) are connectable to a network NW as shown. For example, the network NW includes a wireless base station, a dedicated line, a provider device, a domain name system (DNS) server, the Internet and the like. When an image of a vehicle occupant P is captured by the vehicle indoor camera 95 in the vehicle M(1), a feature quantity of the image is derived by the skill level recognizer 155 and transmitted along with information such as whether driving is performed, driving evaluation, and whether automated driving is performed to the skill level management server 300 through the network NW. The skill level management server 300 stores the same information as the skill level management table 190 illustrated in FIG. 12 and, when the feature quantity of the image is received, performs a process of identifying the vehicle occupant and counts the total number of times of driving and the number of times of automated driving. In addition, when an image of the same vehicle occupant P is captured by the vehicle indoor camera 95 in the other vehicle M(2), a feature quantity of the image is transmitted to the skill level management server 300 and a skill level of the vehicle occupant which matches the feature quantity is returned to the vehicle M(2). In this manner, a skill level counted in a certain vehicle is passed to other vehicles and used therein.

According to the above-described vehicle control system 100, it is possible to recognize a skill level of a vehicle occupant and limit the range in which modes can be changed and selectable automated driving modes or gently perform mode switching when the skill level is low, thereby limiting changes in operational load to a degree of change that the occupant can cope with.

With respect to the above-described embodiment, various modifications, substitutions, deletions and the like may be performed. For example, the method of identifying a vehicle occupant for skill level recognition is not limited to the method of using the vehicle indoor camera 95, and a method by which a vehicle occupant inputs a password or the like to log in may be employed.

What is claim is:

1.-11. (canceled)

12. A vehicle control system comprising:
a driving controller which controls automated driving of automatically controlling at least one of an acceleration/deceleration and steering of a host vehicle or manual driving of controlling both the acceleration/deceleration and steering of the host vehicle on the basis of an operation of an occupant of the host vehicle by executing any of a plurality of modes having different degrees of automated driving;
a skill level recognizer which recognizes a skill level of the occupant of the host vehicle; and
a mode controller which selects a mode to be implemented by the driving controller and controls a time or the length of a traveling distance necessary for the driving controller to change to the mode on the basis of the skill level recognized by the skill level recognizer.

13. The vehicle control system according to claim 12,
wherein the mode controller increases a time or a traveling distance necessary for the driving controller to change modes as a skill level recognized by the skill level recognizer decreases.

14. A vehicle control system comprising:
a driving controller which controls automated driving of automatically controlling at least one of an acceleration/deceleration and steering of a host vehicle or manual driving of controlling both the acceleration/deceleration and steering of the host vehicle on the basis of an operation of an occupant of the host vehicle by executing any of a plurality of modes having different degrees of automated driving;
a skill level recognizer which recognizes a skill level of the occupant of the host vehicle; and
a mode controller which selects a mode implemented by the driving controller and controls change in behavior of the host vehicle when the driving controller ends automated driving and implements manual driving to be changed on the basis of the skill level recognized by the skill level recognizer.

15. The vehicle control system according to claim 12,
wherein the skill level recognizer counts the number of times each occupant of the host vehicle has been present on the basis of an image captured by an image capture unit which captures images and recognizes a skill level of the occupant of the host vehicle on the basis of the counter number of presences.

16. The vehicle control system according to claim 12, further comprising a communication unit which communicates with an external device,
wherein the skill level recognizer recognizes a skill level of the occupant of the host vehicle on the basis of a skill level acquired from the external device through the communication unit.

17. The vehicle control system according to claim 16,
wherein the skill level recognizer transmits information based on an image captured by an image capture unit which captures an image of the interior of the vehicle to the external device using the communication unit.

18. The vehicle control system according to claim 12,
wherein the mode controller limits modes which can be selected by the driving controller as a skill level of the occupant of the host vehicle decreases.

19. The vehicle control system according to claim 12,
wherein the mode controller limits a difference between degrees of automated driving before and after mode change performed by the driving controller as a skill level of the occupant of the host vehicle decreases.

20. The vehicle control system according to claim 19,
wherein, when the difference between degrees of automated driving before and after mode change is limited, the mode controller sequentially changes modes within a limited range.

21. A vehicle control method comprising, through a computer mounted in a vehicle:
controlling automated driving of automatically controlling at least one of an acceleration/deceleration and steering of a host vehicle or manual driving of controlling both the acceleration/deceleration and steering of the host vehicle on the basis of an operation of an occupant of the host vehicle by implementing any of a plurality of modes having different degrees of automated driving;
recognizing a skill level of the occupant of the host vehicle;
selecting the implemented mode; and
controlling a time or the length of a traveling distance necessary to change to the mode on the basis of the recognized skill level.

22. A computer readable non-transitory storage medium having a program stored therein, the program causing a computer mounted in a vehicle:
to control automated driving of automatically controlling at least one of an acceleration/deceleration and steering of a host vehicle or manual driving of controlling both the acceleration/deceleration and steering of the host vehicle on the basis of an operation of an occupant of the host vehicle by implementing any of a plurality of modes having different degrees of automated driving;
to recognize a skill level of the occupant of the host vehicle;
to select the implemented mode; and
to control a time or the length of a traveling distance necessary to change to the mode on the basis of the recognized skill level.

23. A vehicle control method comprising, through a computer mounted in a vehicle:
controlling automated driving of automatically controlling at least one of an acceleration/deceleration and steering of a host vehicle or manual driving of controlling both the acceleration/deceleration and steering of the host vehicle on the basis of an operation of an occupant of the host vehicle by implementing any of a plurality of modes having different degrees of automated driving;
recognizing a skill level of the occupant of the host vehicle;
selecting the implemented mode; and
controlling change in behavior of the host vehicle when automated driving is ended and manual driving is implemented on the basis of the recognized skill level.

24. A computer readable non-transitory storage medium having a program stored therein, the program causing a computer mounted in a vehicle:
to control automated driving of automatically controlling at least one of an acceleration/deceleration and steering of a host vehicle or manual driving of controlling both the acceleration/deceleration and steering of the host vehicle on the basis of an operation of an occupant of the host vehicle by implementing any of a plurality of modes having different degrees of automated driving;
to recognize a skill level of the occupant of the host vehicle;
to select the implemented mode; and
to control changed in behavior of the host vehicle when automated driving is ended and manual driving is implemented on the basis of the recognized skill level.
